(19) United States
(12) Patent Application Publication
(10) Pub. No.: US 2006/0191088 A1
(43) Pub. Date: Aug. 31, 2006

(54) Paint application device

(76) Inventors: Matthew G. Goulet, Milwaukee, WI (US); Craig S. Serio, New Berlin, WI (US); Michael E. Allex, Verona, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 11/354,574

(22) Filed: Feb. 15, 2006

Related U.S. Application Data
(63) Continuation of application No. PCT/US03/26289, filed on Aug. 15, 2003.

(51) Int. Cl. B05C 17/02

(52) U.S. Cl. 15/144.1; 15/210.1; 15/230.11

(57) ABSTRACT

A paint application device having a head pivotally connected to a handle which may be rotated as desired and locked when necessary.

### CROSS-REFERENCE TO RELATED APPLICATIONS

This application is a continuation that claims priority under 35 U.S.C. §120 of Patent Cooperation Treaty International Application No. PCT/US2003/026289 filed on Aug. 15, 2003 entitled “PAINT APPLICATION DEVICE”, the contents of which are herein incorporated by reference.

### FIELD OF THE DISCLOSURE

The present invention generally relates to paint application devices and, more particularly, to paint application devices having an adjustable connection between a handle and a head of the device.

Background of the Invention Paint applicators are well known. Most commonly, such devices are provided in the form of bristled brushes, matted rollers, and foam pads. Brushes allow for accurate paint application in that they provide a relatively small interface area with the surface being painted and can be provided in a wide array of sizes.

However, brushes are relatively slow due to their typical sizes, and limited paint holding volume. Moreover, depending on the quality of paint and diligence of the worker, brushes can often result in visible brush strokes and loose bristles in the dried paint.

Matted rollers are therefore often the tool of choice for fast paint application to relatively large surfaces such as walls and ceilings. The matted material forming the roller is sufficiently absorbent to hold a large volume of paint.

That volume can be further enhanced by tailoring the width and diameter of the roller to the given application. However, given such size and shape, accurate control of the paint application is often difficult, with application to non-flat surfaces often being difficult, if not impossible. Moreover, the rolling action of the application often results in splattering of the paint onto surrounding areas and articles.

Foam pads are therefore often the tool of choice given the demands of the application and drawbacks of the above-referenced alternatives. Such applicators absorb a relatively high volume of paint, and can be dabbed onto intricate textures.

Moreover, such pads often have a straight or angular edge enabling application of paint along a straight trim line or within a corner and the like.

With any of the above tools, it is often desirable to provide a mechanism by which an extension pole can be attached to enable high or otherwise difficult to reach spots to be painted. However, it is not only desirable to reach such spots, it is also desirable to allow the applicator to pivot relative to the handle to facilitate application. This is true of applications without the use of extension poles as well.

### DESCRIPTION OF THE DRAWINGS

FIG. 1A is a perspective view of a paint pad applicator constructed in accordance with the teachings of the disclosure;

FIG. 1B is a perspective view of the paint pad applicator of FIG. 1, but depicted in a different angular position;

FIG. 2 is a sectional view of the paint pad applicator of FIG. 1, taken along line 3-3 of FIG. 1;

FIG. 3 is a perspective view of an alternative embodiment of a paint pad applicator constructed in accordance with the teachings of the disclosure;

FIG. 4 is a rear view of the paint pad applicator of FIG. 1;

FIG. 5 is a side sectional view of the paint pad applicator taken along line 5-5 of FIG. 4;

FIG. 6 is an enlarged detail of the sectional view of FIG. 5;

FIG. 7 is a perspective view of a shielded roller applicator constructed in accordance with the teachings of the disclosure;

FIG. 8A is an enlarged top perspective view of the shielded roller of FIG. 7 with the handle and knob removed for clarity;

FIG. 8B is a perspective view of the handle used with the shielded roller applicator of FIG. 7;

FIG. 9 is a knob used with the shielded roller applicator of FIG. 7;

FIG. 10 is a perspective view of an alternative embodiment of a shielded roller applicator constructed in accordance with the teachings of the disclosure;

FIG. 11 is a side elevation view of the shielded roller applicator of FIG. 10;

FIG. 12 is a plan view of the shielded roller applicator of FIG. 10;

FIG. 13 is a partial side sectional view of the shielded roller of FIG. 10; and

FIG. 14 is a sectional view of the shielded roller taken along line 14-14 of FIG. 13.

While the following detailed description sets forth various modifications and alternative constructions, certain illustrative embodiments thereof have been shown in the drawings and will be described below in detail. It should be understood, however, that there is no intention to limit the disclosure to these specific forms disclosed, but on the contrary, the intention is to cover all modifications, alternative constructions, and equivalents falling within the spirit and scope of the invention as defined by the appended claims.

### DETAILED DESCRIPTION

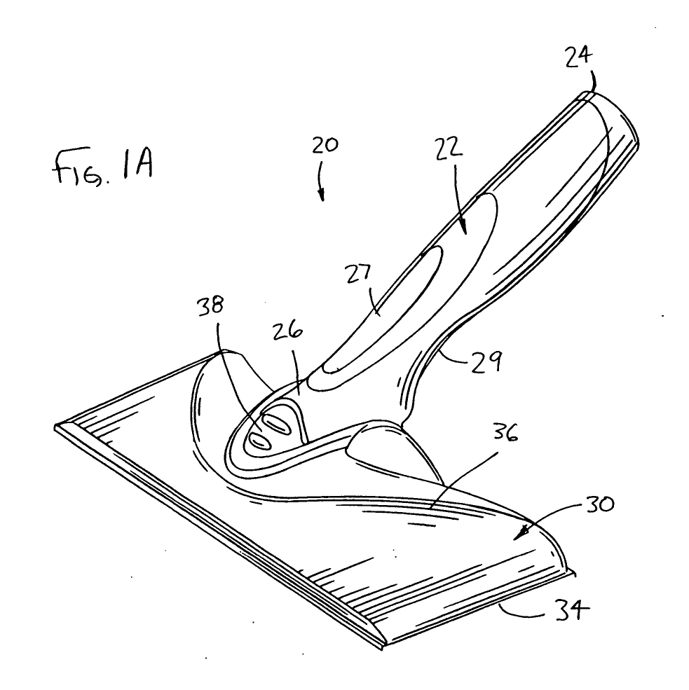

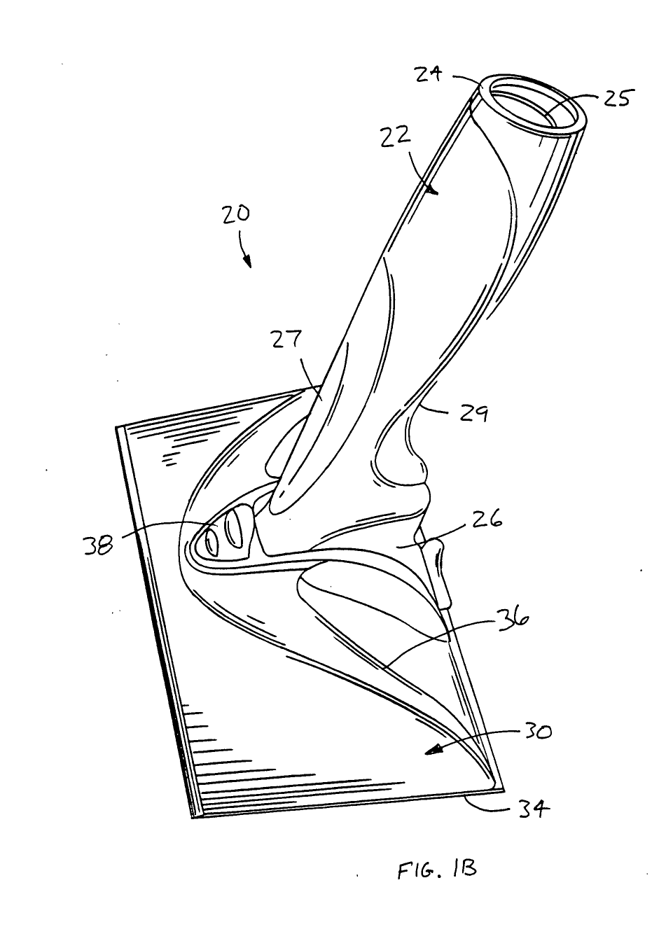

Referring now to the drawings, and with specific reference to FIGS. 1A & 1B, a paint applicator constructed in accordance with the teachings of the disclosure is generally referred to by reference numeral 20. While the applicator of FIGS. 1-2 is depicted as a pad applicator, it is to be understood that the teachings of the disclosure can be used in conjunction with many other types of applicators such as, but not limited to, rollers, brushes, and the like.

The pad applicator 20 includes a handle 22 sized to comfortably fit a user's hand. The handle 22 has a proximal end 24 formed with internal threads 25 for receiving an extension tool, such as a threaded pole. Near a distal end 26 of the handle 22 are a pair of raised bosses 28 (only one shown in FIG. 2). As best illustrated at FIG. 2, the distal end 26 is sized for insertion into a head 30. It will also be noted that the handle 22 is ergonomically designed for enhanced grip and improved aesthetics. More specifically, the handle includes a thumb grip 27 and finger grip 29 which are both contoured to fit the hand of a user. Moreover, such grips 27,29 may be manufactured from Santoprene or other polymer or material allowing from enhanced traction and feel.

The head 30 defines a top recess 31 sized to receive the distal end of the handle 22. The head includes a pair of internal cylinders 32 sized to rotatably receive the raised bosses 28 of the handle, so that the head 30 may pivot relative to the handle 22 about an axis 33 defined by the bosses 28 and cylinders 32. The head 30 may have a bottom surface 34 substantially rectangular in shape so as to enable receipt of a substantially rectangular foam pad (not shown). However, it is to be understood that the head 30 need not be rectangular, but could be provided in a variety of different shapes as well. The head 30 further includes a contoured top surface 36 adding to the aesthetics of the applicator 20.

A locking switch 38 is slidably coupled to the head 30 for locking the head 30 at a particular angle relative to the handle 22. As best shown in FIG. 2, the switch 38 includes a base portion 40 having a finger 41 sized for insertion into an internal recess 42 formed in the distal end of the handle 22. When slid rearward (i.e., toward the handle), the finger 41 engages the recess 42 to lock the handle 22 at a particular angle with respect to the head 30. When the switch 38 is pushed forward (i.e., away from the handle), the finger 41 disengages the recess 42 and the head 30 is allowed to freely pivot with respect to the handle 22. FIGS. 1A & 1B illustrate the paint applicator 20 in which the head 30 is positioned at two different angles with respect to the handle 22.

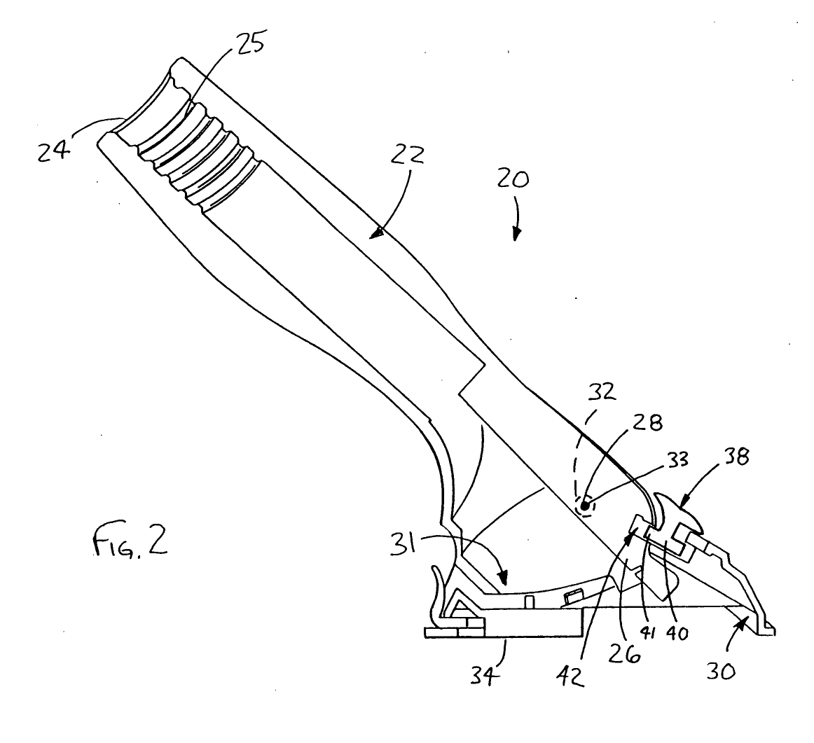

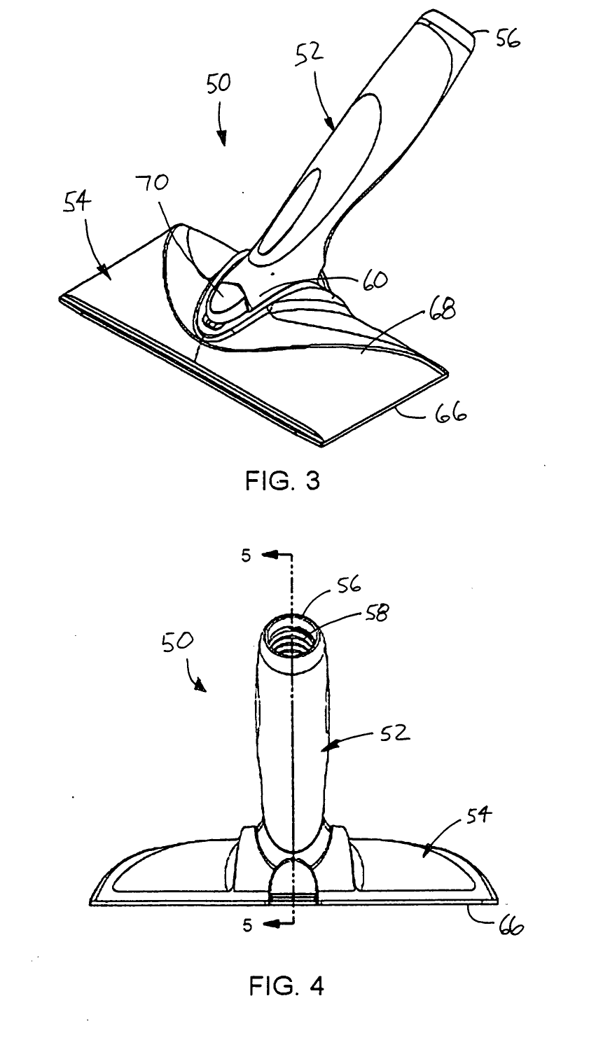

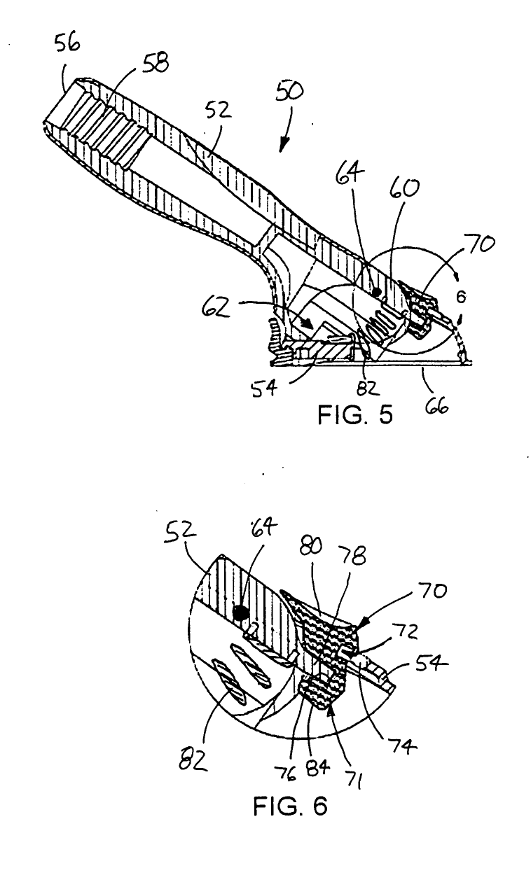

An alternative pad applicator 50 is illustrated in FIGS. 3-6. The pad applicator 50 includes a handle 52 and head 54 similar to the previous embodiment, but incorporates a different locking mechanism. Accordingly, the handle 52 includes a proximal end 56 formed with internal threads 58 (FIG. 5) for receiving a threaded extension pole. A pair of sockets (not shown) is formed near a distal end 60 of the handle 52. The distal end 60 is sized for insertion into the head 54.

The head 54 defines a top opening 62 sized to receive the handle distal end 60. The head 54 includes a pair of bosses (not shown) sized for insertion into the sockets formed in the handle 52, so that the head 54 may pivot with respect to the handle 52 about an axis 64 defined by the bosses and sockets. The head 54 further includes a bottom surface 66 adapted to receive a rectangular foam pad (not shown).

According to the illustrated embodiment, the bottom surface 66 has a rectangular shape, however the bottom surface may be formed in other shapes. The head further includes a contoured top surface 68.

A locking switch 70 is slidably coupled to the head 54 for locking the head 54 in at least one particular angle with respect to the handle 52. As best illustrated in FIGS. 5 & 6, the locking switch 70 defines a slot 72 sized to slidably engage a lip 74 formed on the head 54. A base portion 71 of the switch 70 further includes a groove 76 sized to receive a tab 78 formed at the distal end 60 of the handle 52. A top surface of the switch is formed with a depression 80 sized to receive a user's finger. Accordingly, when the switch 70 is slid rearward (i.e., toward the handle 52), the groove 76 engages the tab 78 to hold the head 54 at a particular angle <BR> <BR>with respect to the handle 52. When moved forward (i.e., away from the handle 52), the groove 76 disengages the tab 78 to allow the head 54 to freely pivot with respect to the handle 52.

A resilient member, such as a spring 82, may be coupled between the handle 52 and head 54 to bias the head 54 in a home position, thereby to limit unintended rotation of the head 54 when the switch 70 is disengaged from the handle 52. For example, the home position may be illustrated by FIG. 1 where the included angle between the handle 54 and a plane defined by the head bottom surface 66 is at its smallest.

The illustrated embodiment further allows the head 54 to be locked at a second angle with respect to the handle 52. With the switch 70 slid forward, the tab 78 may be rotated past a bottom end 84 of the switch. The switch 70 may then be slid rearward so that the tab 78 is trapped below the switch 70. As a result, the head 54 of the pad applicator 50 may be selectively locked at two different angles with respect to the handle 52.

Turning now to FIGS. 7-9, a roller applicator constructed in accordance with the teachings of the disclosure is generally referred to by reference numeral 100. The roller applicator 100 includes a shroud 102 to which a handle 104 is pivotally attached. The shroud 102 is depicted as being semi-cylindrical in shape to receive a matted roller (not shown) in a conventional fashion. More specifically, the roller applicator 100 may include a rod or other axle adapted to rotationally hold a matted roller.

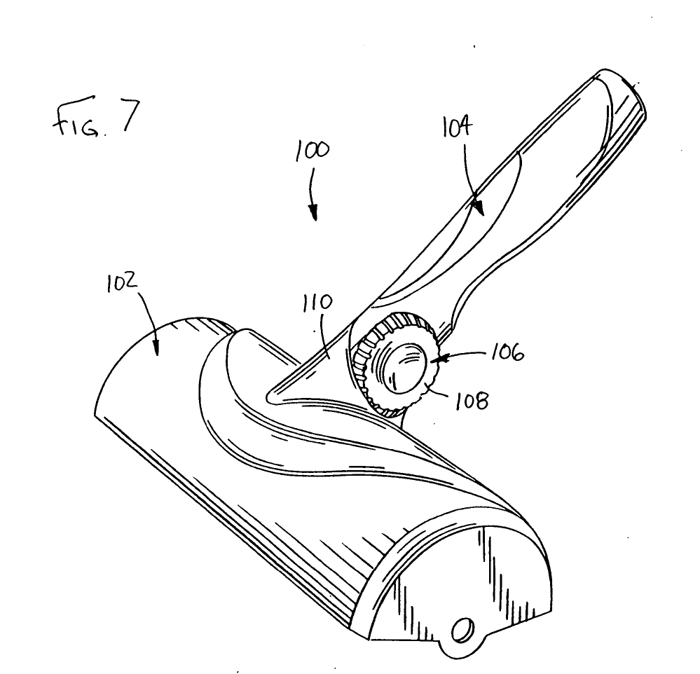

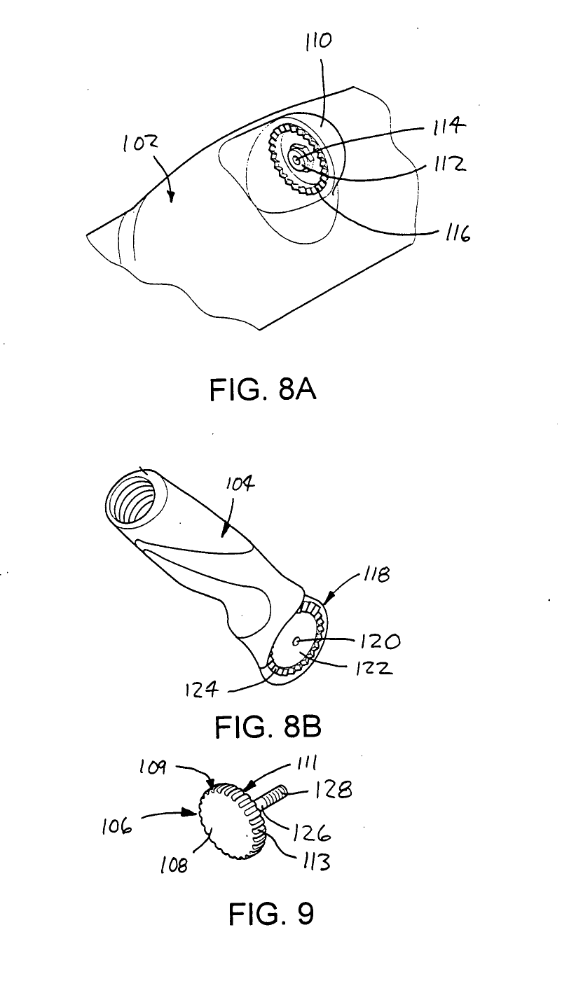

The handle 104 is substantially the same in appearance and construction as the handles 22,52 of the above pad applicators 20,50. However, the handle 104 is connected to the shroud 102 by a screw 106 having a knob 108 attached thereto. As best shown in FIG. 8A, a connection portion 1 10 extends from a top of the shroud 102. The connection portion 110 includes a cylindrical boss 112 defining a threaded receptacle 114. A series of gear teeth 116 are formed in the connection portion 110 and are concentric with the cylindrical boss 112. The handle 104 has a distal end 118 defining an aperture 120 (FIG. 8B). A flat surface 122 surrounds the aperture 120, and a series of gear teeth 124 are concentric about the aperture 120. The gear teeth 124 are formed to complement the gear teeth 116 formed in the shroud connection portion 110. The screw 106 is illustrated in FIG. 9 having a shaft 126 with a threaded end 128 and the knob 108 attached to an opposite end. The knob 108 has a side wall 109 having a thickness sufficient to facilitate manual grasping by a user.

The knob 108 further defines a compression surface 111 for engaging the handle distal end 118. In the illustrated embodiment, the knob side wall 109 is generally cylindrical and defines a circumference that is significantly larger than the screw <BR> <BR>head. As used herein, “significantly larger” means at least twice the circumference of a standard screw head. The knob side wall 109 may be formed with knurls 113 to allow for better gripping.

When assembled, the distal end 118 of the handle 104 is placed adjacent the connection portion 1 10 of the shroud 102 so that the gear teeth 116,124 are engaged. The screw 106 is inserted through the handle aperture 120 until the threaded end 128 engages the threaded receptacle 114. The screw 106 may then be rotated using the knob 108 so that the screw 106 threadably engages the receptacle 114. The screw 106 may be tightened until the knob compression surface 111 presses against the handle distal end 118, thereby frictionally securing the handle 104 against the connection portion 110 of the shroud 102.

The screw 106 may be released to reorient the handle 104 with respect to the shroud 102 to obtain a different handle angle. The gear teeth 116,124 define several discrete angles at which the shroud 102 may be secured with respect to the handle 104. Accordingly, the user may simply loosen the screw 106, rotate the handle 104 to the desired angle that still allows the gear teeth 116,124 to mate, and re-tighten the screw 106 to secure the handle in the desired orientation.

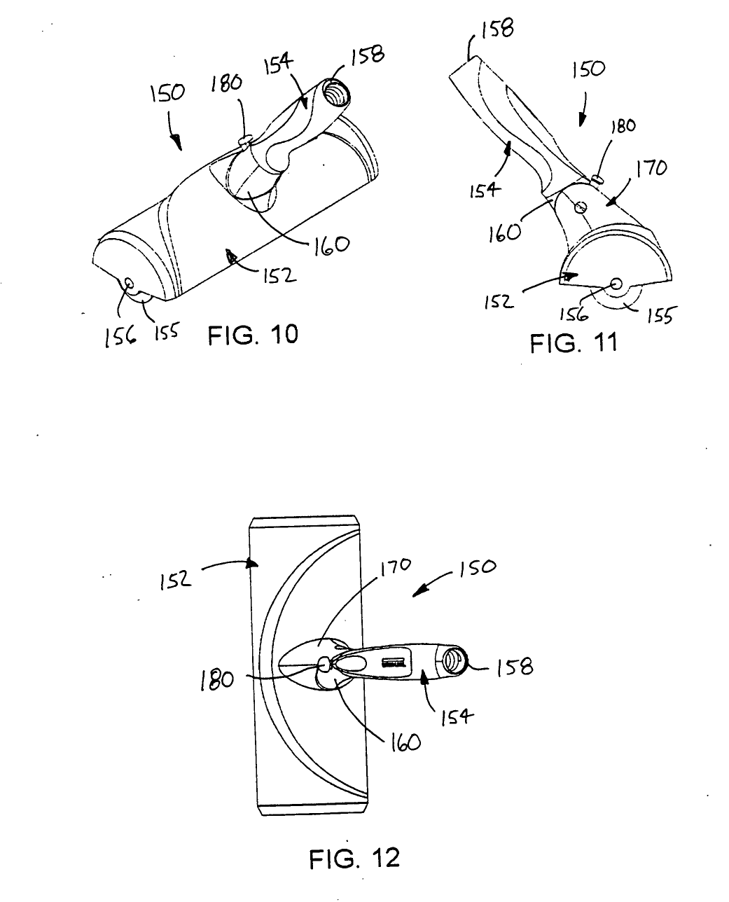

An alternative roller applicator constructed in accordance with the teachings of the disclosure is illustrated in FIGS. 10-14 and generally referred to with reference numeral 150. Similar to the immediately preceding embodiment, the roller applicator 150 includes a shroud 152 to which a handle 154 is pivotally attached. The shroud 152 is depicted as being semi-cylindrical in shape to receive a matted roller 155 in a conventional fashion. More specifically, the roller applicator 150 may include a rod or other axle 156 adapted to rotationally hold the matted roller 155.

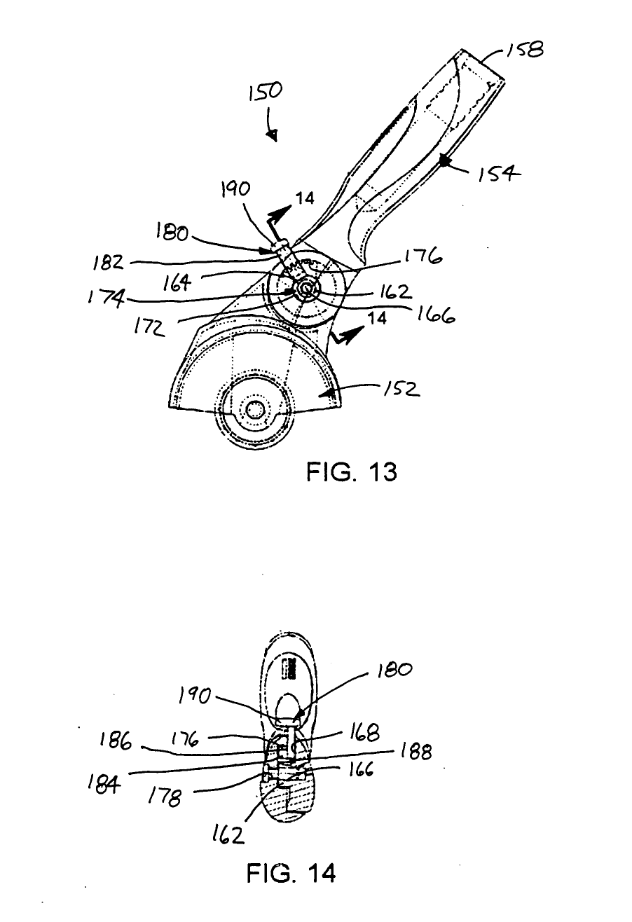

The handle 154 has a proximal end 158 substantially the same in construction and appearance as the previously disclosed handles. A distal end 160 of the handle 154 includes a boss 162 having a flat side surface 164 (FIGS. 13 & 14). A threaded receptacle 166 is formed in the boss 162. A channel 168 extends from adjacent the flat side surface 164 to a periphery of the distal end 160.

The shroud 152 includes a connection portion 170 extending from a top thereof. The connection portion includes a recess 172 having a central portion 174 sized to receive the boss 162. The recess 172 further includes a locking portion formed with a series of stops, such as notches 176, which, as explained below, define angular locking positions for the handle 154. In the illustrated embodiment, the recess 172 is shown having eight notches 176, however more or less notches may be provided depending on the number of desired handle angle positions. An aperture 178 is formed through a center of the recess central portion 174.

A button 180 is provided for locking the handle 154 at a desired angle relative to the shroud 152. As best shown in FIGS. 13 & 14, the button 180 includes a shaft 182 sized for insertion into and slidable within the channel 168 formed in the handle distal end 160. An enlarged base 184 is attached to an interior end of the shaft 182, projects into the recess 172, and has a projection, such as a finger 186, sized to engage at least one of the notches 176 formed in the shroud connection portion 170.

The shaft 182 extends outwardly from the channel 168 to define a free end. An enlarged head 190 is attached to the free end to facilitate manual engagement by the user.

While, in the illustrated embodiment, the locking mechanism comprises a finger engaging a notch, it will be appreciated that other types of stops and projections may be used. For example, the stops may be provided as a series of apertures and the projection may be a pin that is selectively insertable into the apertures. In addition, tongue and groove or other types of locking mechanism engagements may be employed.

A resilient member, such as a spring 188, is disposed between the button base 184 and the flat surface 164 of the boss 162, thereby to bias the finger 186 into a selected notch 176. The button base 184 and flat surface 164 may include a recess for receiving the ends of the spring 188.

To assemble the roller applicator 150, the spring 188 is attached to the button 180 and the button 180 is inserted into the channel 168 so that the spring engages the flat surface 164. The handle 154 and button are then positioned adjacent the connection portion 170 so that the boss 162 is inserted into the recess 172. A screw 190 is inserted through the aperture 178 and threaded into the threaded receptacle 166, thereby to secure the handle 154 to the shroud 152.

Once assembled, the spring 188 will bias the button 180 away from the boss 162 so that the finger 186 engages a notch 176. To adjust the angle of the handle 154, the user must depress the button 180 against the force of the spring 188 until the finger 186 is disengaged from the notches 176 and simultaneously rotate the handle to the desired angle with respect to the shroud 152. The user may then release the button 180, thereby allowing the force of the spring 188 to bias the finger into engagement with the selected notch 176, thereby locking the handle 154 in the new angular position with respect to the shroud 152.

The foregoing detailed description has been given for clearness of understanding only, and no unnecessary limitations should be understood therefrom, as modifications would be obvious to those skilled in the art.

What is claimed is:

1. A paint applicator comprising:
a handle having a proximal end and a distal end; a head pivotally coupled to the handle and having a top recess sized to receive the handle distal end; and a locking switch slidably coupled to the head and movable between a forward position and a rearward position, the locking switch including a base portion sized to engage the handle distal end when the locking switch is in the rearward position, thereby to lock the handle at a particular angle with respect to the head, and the locking switch bottom portion disengaging the handle distal end when the locking switch is in the forward position thereby allowing the handle to freely pivot with respect to the head.

2. The paint applicator of claim 1, in which the handle distal end defines an internal recess and the locking switch base portion includes a finger sized for insertion into the internal recess, wherein the finger engages the internal recess when the locking switch is in the rearward position and wherein the finger disengages the internal recess when the locking switch is in the forward position.

3. The paint applicator of claim 1, in which the handle distal ends includes a tab and the locking switch base portion defines a groove sized to receive the tab, wherein the groove engages the tab when the locking switch is in the rearward position and wherein the groove disengages the tab when the locking switch is in the forward position.

4. The paint applicator of claim 3, in which the locking switch further defines a bottom end spaced from the groove and sized to engage the handle tab when the switch is in the rearward position, wherein, when the handle is rotated so that the tab is positioned below the locking switch bottom end and the locking switch is moved to the rearward position, the locking switch bottom end engages the handle tab to lock the handle at a second particular angle with respect to the head.

5. The paint applicator of claim 1, further comprising a resilient member coupled between the head and the handle for biasing the head toward a home position.

6. The paint applicator of claim 1, in which the head includes a bottom surface having a substantially rectangular shape.

7. The paint applicator of claim 1, in which the bottom surface is adapted to receive a foam pad.

8. A paint applicator comprising:
a handle having a proximal end and a distal end, the distal end including an aperture and a series of gear teeth extending about a circle concentric with the aperture;
a head including a connection portion having a cylindrical boss defining a threaded recess and a series of gear teeth extending about a circle concentric with the threaded recess, wherein the connection portion gear teeth are complementary to the handle gear teeth;
a screw having a shaft sized for insertion through the handle aperture, a threaded end for threadably engaging the threaded recess, and a head; and
a knob attached to a head of the screw for rotating the screw, the knob having a side wall with a thickness sufficient for manual grasping and a compression surface that engages and presses the handle distal end into engagement with the head connection portion so that the handle gear teeth engage the connection portion gear teeth, thereby to secure the handle in one of several particular angles with respect to the head.

9. The paint applicator of claim 8, in which the knob side wall is generally cylindrical and defines a circumference that is significantly larger than the screw head.

10. The paint applicator of claim 8, in which the knob side wall is formed with knurls.

11. The paint applicator of claim 8, in which the head comprises a shroud and the connection portion projects from a top of the shroud.

12. The paint applicator of claim 9, in which the shroud is adapted to receive a matted roller.

13. A paint applicator comprising:
a handle having a proximal end and a distal end, the distal end including a boss having a flat side surface, a threaded receptacle formed in the boss, and a channel extending from the boss flat side surface to a periphery of the handle distal end;
a head including a connection portion coupled to the handle distal end, the connection portion defining a recess having a central portion sized to receive the handle boss and a locking portion formed with a series of stops;
a button having an interior end disposed between the handle and the head, the interior portion including a projection sized to engage a stop selected from the series of stops in the head recess locking portion, a shaft attached to the interior end and slidable within the handle channel, the shaft extending outward from the channel to define a free end, and an exterior end attached to the free end of the shaft and including an enlarged head; and
a resilient member disposed between the boss flat surface and the button base, wherein the button is biased by the resilient member toward a locked position in which the button projection engages the stop, the button being movable against the force of the resilient member to an adjust position in which the handle may be rotated with respect to the head.

14. The paint applicator of claim 13, in which the series of stops comprises a series of notches formed in the head recess locking portion, and in which the button projection comprises a finger sized to engage at least one of the notches.

15. The paint applicator of claim 13, in which the resilient member comprises a spring.

16. The paint applicator of claim 13, in which the handle boss defines a threaded receptacle and in which the head recess defines an aperture, the paint applicator further including a screw having a shaft sized for insertion through the head recess aperture and adapted to threadably engage the handle boss threaded receptacle, thereby to couple the head to the handle.

17. The paint applicator of claim 13, in which the head comprises a shroud and the connection portion projects from a top of the shroud.

18. The paint applicator of claim 13, in which the shroud is adapted to receive a matted roller.
